(19) United States
(12) Patent Application Publication
(10) Pub. No.: US 2024/0342894 A1
(43) Pub. Date: Oct. 17, 2024

(54) ELECTRICALLY OPERABLE DEVICE AND METHOD

(71) Applicant: FESTOOL GMBH, Wendlingen (DE)

(72) Inventors: Robert WEIDNER, Bohlsen (DE); Andreas ARGUBI-WOLLESEN, Hamburg (DE); Bernward OTTEN, Hamburg (DE); Dominic Richard ENDER, Nürtingen (DE); Björn HIPP, Hamburg (DE)

(21) Appl. No.: 18/683,195

(22) PCT Filed: Aug. 12, 2022
(86) PCT No.: PCT/EP2022/072715

§ 371 Date: Feb. 12, 2024

(30) Foreign Application Priority Data
Aug. 13, 2021 (DE) 10 2021 208 904.6

(51) Int. Cl. B25J 9/00

(52) U.S. Cl. CPC B25J 9/0006

(57) ABSTRACT

An electrically operable device, which is designed in particular as an exoskeleton or as a suction device, including a base section for attachment to a body section, in particular the torso, of the human body, an actuator and/or drive device, a control device for controlling the actuator and/or drive device, and an operating element which is used for user input to the control device and which is operated by the user of the electrically operable device, a control device for controlling the actuator and/or drive device, and an operating element which is used for user input into the control device and which can be operated manually by the user of the electrically operable device during use of the electrically operable device.

The invention relates to an electrically operable device, which is designed in particular as an exoskeleton or as a suction device, comprising a base section for attachment to a body section, in particular the torso, of the human body, an actuator and/or drive device and a control device for controlling the actuator and/or drive device.

U.S. Pat. No. 8,416,186B2 describes an operating element for operating televisions and video games. EP2699971A1 describes a hand-held control unit for controlling a robot. EP3558601B1 describes a control unit for controlling a robot. WO2019072444A2 describes exoskeletons and methods for controlling the support force of an exoskeleton on the basis of signals from a tool.

One object of the invention is to provide an electrically operable device that is easy to use.

The object is solved by an electrically operable device according to claim 1. The electrically operable device comprises an operating element which is used for user input into the control device and which can be operated manually by the user of the electrically operable device during use of the electrically operable device.

The electrically operable device is preferably designed as an exoskeleton. The user of the exoskeleton can expediently use the operating element while using the exoskeleton. In particular, this means that the user can expediently reach and operate the operating element when using the exoskeleton. In particular, the simplicity of operation is such that the operating element enables blind operation of the operating element, which facilitates handling when setting certain parameters to be set via the operating element while working/wearing the exoskeleton. The possibility of blind operation is preferably realized via a shape, haptics and/or arrangement of buttons on the operating element. Optionally, acoustic feedback can be provided or control via speech and/or gestures can be possible.

Preferably, the electrically operable device can be designed as a suction device. In the case of a suction device, the operating element can be attached to a hose nozzle, for example. In particular, the user can operate the suction device via the operating element when working with a power tool coupled to the suction device. As an example, the suction device is a suction device carried on the user's back. The operating element can, for example, be connected to a base section of the suction device via a cable and attached to a shoulder strap, a belt or a pelvic strap, for example, so that the user can reach the operating element manually when the user is carrying the suction device on their back.

Advantageous further developments are the subject of the subclaims.

The invention further relates to a method according to claim 21.

Further exemplary details and exemplary embodiments are explained below with reference to the figures. Thereby shows

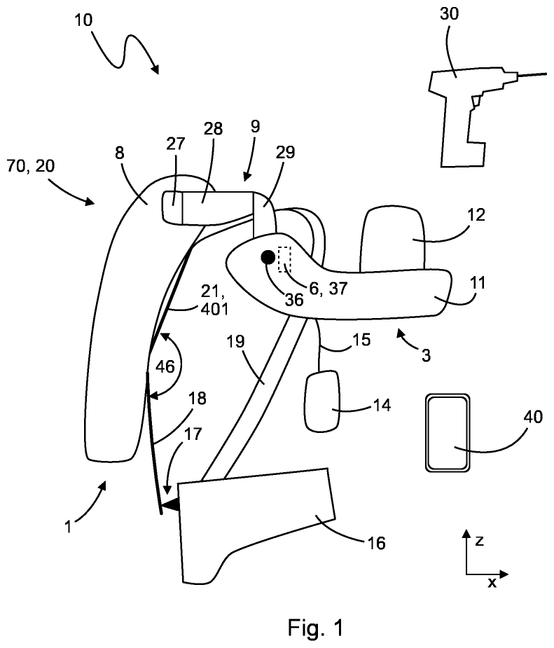

FIG. 1 a schematic side view of an exoskeleton device,

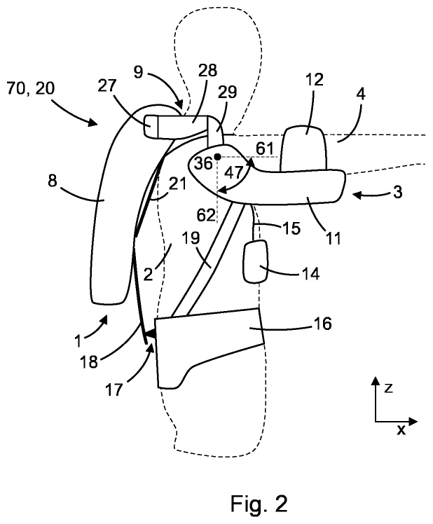

FIG. 2 a schematic side view of an exoskeleton worn by a user,

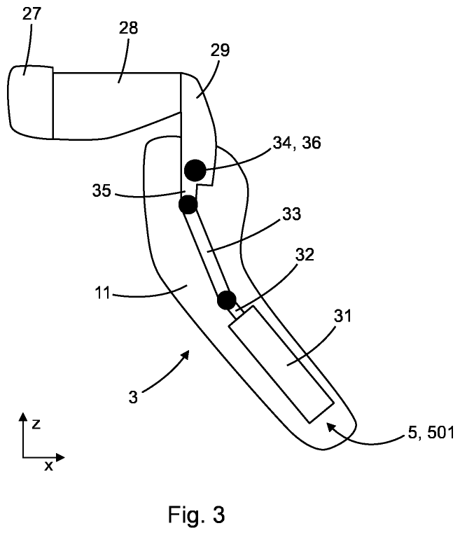

FIG. 3 a schematic detailed view of a support section of the exoskeleton,

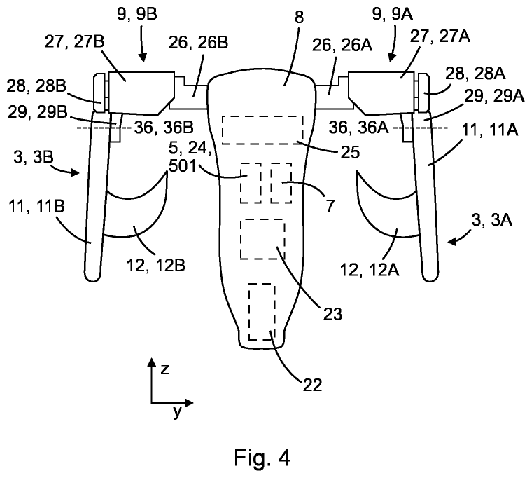

FIG. 4 a schematic rear view of the exoskeleton,

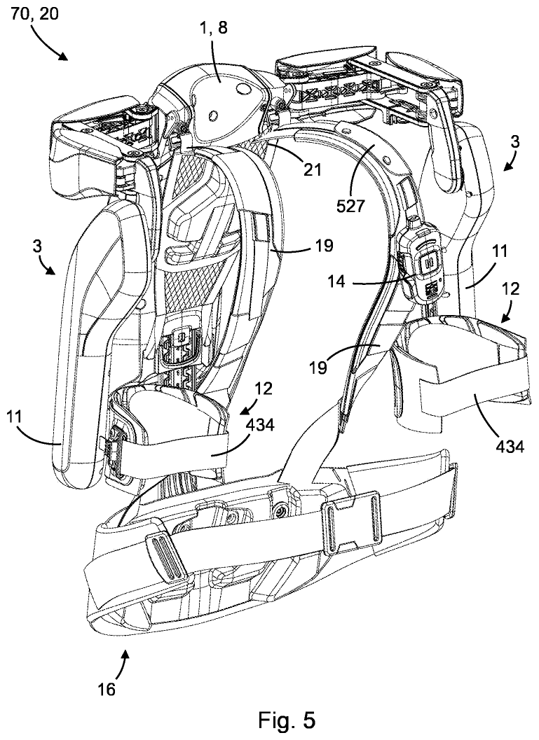

FIG. 5 a perspective view of an exemplary embodiment of the exoskeleton,

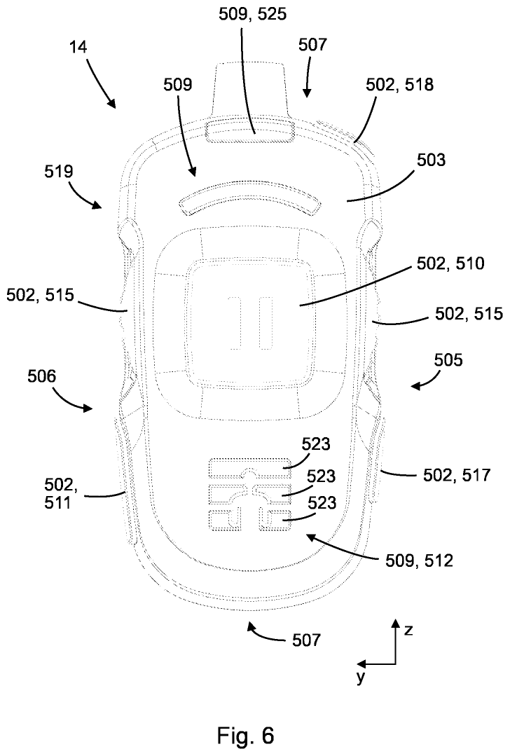

FIG. 6 a top view of an operating element,

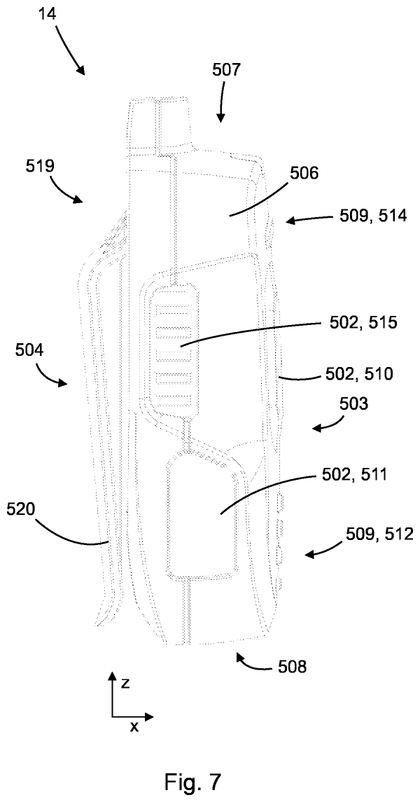

FIG. 7 a side view of the operating element,

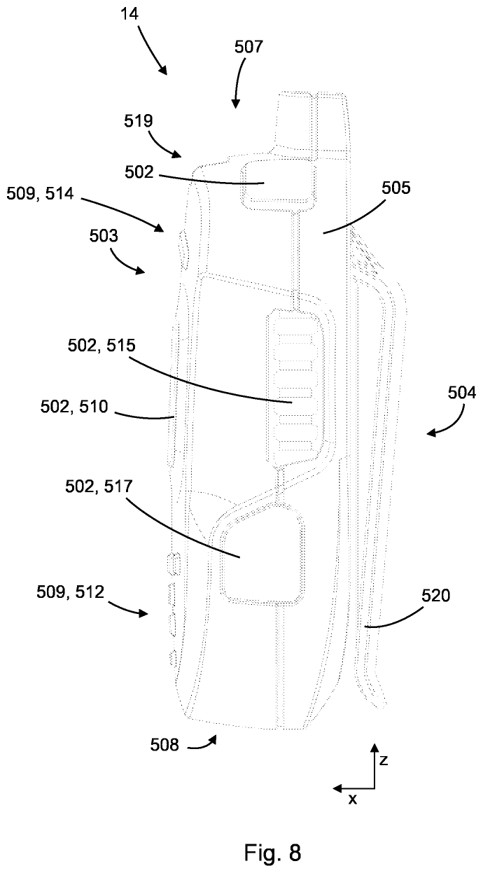

FIG. 8 another side view of the operating element,

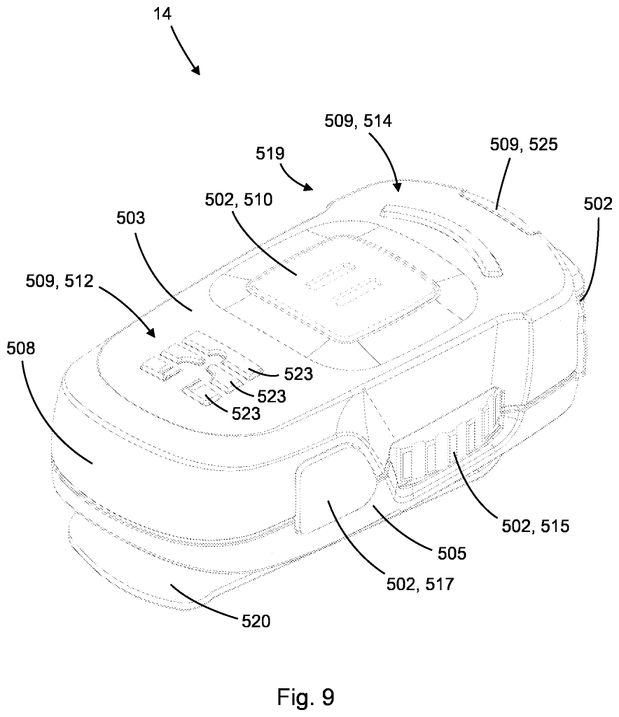

FIG. 9 a perspective view of the operating element,

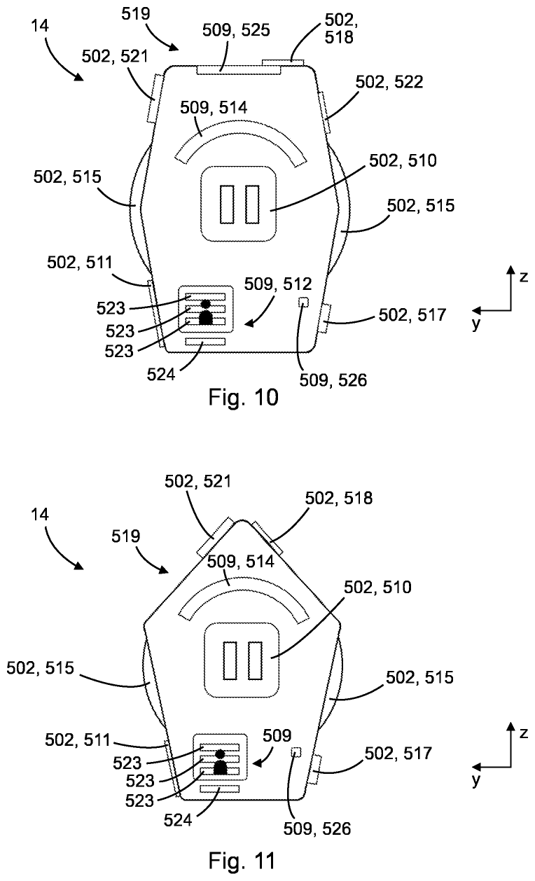

FIG. 10 a top view of an operating element according to a further variant,

FIG. 11 a top view of an operating element according to a further variant and

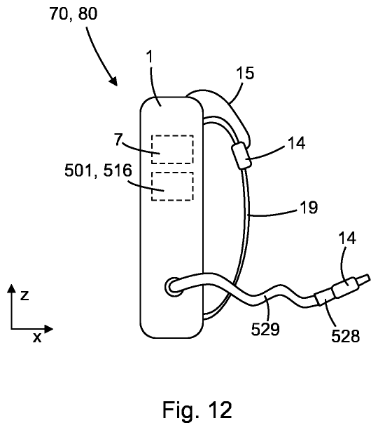

FIG. 12 a schematic side view of a suction device.

In the following explanations, reference is made to the spatial directions x-direction, y-direction and z-direction, which are drawn orthogonally to each other in the figures. The z-direction can also be referred to as the vertical direction, the x-direction as the depth direction and the y-direction as the width direction.

FIG. 12 shows an electrically operable device 70, which is designed purely optionally as a suction device 80. FIGS. 1, 2, 4 and 5 show the electrically operable device 70 in an implementation as exoskeleton 20.

The electrically operable device 70 comprises a base section 1 for attachment to a body section, in particular the torso 2, of the human body. The electrically operable device 70 further comprises an actuator and/or drive device 501 and a control device 7 for controlling the actuator and/or drive device 501. Furthermore, the electrically operable device 70 comprises an operating element 14. The operating element 14 is used for user input into the control device 7. The operating element 14 can be operated manually by the user of the electrically operable device during use of the electrically operable device. The operating element 14 expediently comprises an operating element housing 519.

Exemplary embodiments of the operating element 14 are shown in FIGS. 6 to 11.

Preferably, the operating element 14 is designed as a manual operating element that can be grasped by hand, in particular one that is not integral with the electrically operable device 70. In particular, the operating element 14 comprises a plurality of input elements 502. Preferably, the input elements 502 are arranged such that all input elements 502 can be operated by a hand grasping the operating element 14 and thereby holding it. As an example, the input elements 502 are arranged on different sides and/or on different surfaces of the operating element. Several of the input elements 502 are preferably designed as respective buttons. In particular, there is at most one button on each side and/or surface of the operating element 14. In this way, it can be achieved that the user, when reaching for a side of the operating element 14, can only press the respective button present on that side. Expediently, the arrangement of the input elements 502 enables blind operation of the input elements 502.

The operating element 14 expediently comprises a front side 503, which in particular represents a side of the operating element 14 with the largest surface area. The operating element further comprises a rear side 504, which is aligned in particular in the opposite direction to the front side 503, a first lateral side 505, which is exemplarily designed as a longitudinal side, and a second lateral side 506, which is exemplarily designed as a longitudinal side and is aligned in particular in the opposite direction to the first lateral side 505. The operating element 14 further comprises an upper side 507 and an underside 508, which is aligned in particular in the opposite direction to the upper side 507.

Preferably, the operating element 14 has a basic shape of a cuboid, in particular with rounded corners and/or rounded edges, as shown, for example, in FIGS. 6 to 9.

The operating element 14 shall be discussed in a spatial orientation in which the front side 503 is oriented perpendicular to the x-direction and towards the front, and the top side 507 is oriented upwards perpendicular to the z-direction.

Purely by way of example, at least one input element 502 is arranged on the front side 503, the first lateral side 505, the second lateral side 506 and the top side, respectively. Expediently, no input element 502, in particular no button, is arranged on the underside 508 and the rear side 504.

Preferably, several, in particular all, of the input elements 502 differ from one another in their shape, size, optical structure and/or haptic structure. This configuration of the input elements 502 can reduce or eliminate the risk of confusion of input elements 502.

Expediently, each shape, size, optical structure and/or haptic structure of an input element 502, in particular of a button of the operating element 14, occurs only once.

Optionally, different button press times are defined for input elements 502 arranged as buttons on opposite sides and/or surfaces. Each button-press time is a period of time for which the respective button must be pressed at least or at most so that the pressing of the button is recognized by the electrically operable device, for example the exoskeleton 20 or the suction device 80, as user input and an associated function is expediently triggered. By defining different button-press times, the pressing of an incorrect button can be expediently be prevented from being recognized as user input and/or an associated function from being triggered, in particular unintentionally, if the operating element 14 is held incorrectly, for example if it is held when the operating element is rotated by 180 degrees relative to its intended orientation in the user's hand.

Preferably, each input element 502 designed as a button is at least as large as a fingertip of an adult person.

Optionally, the input elements 502 can each have a blind code marking. Optionally, the surface of the input elements 502, which are designed as buttons, may have haptically perceptible symbols which are, for example, raised or recessed and in particular facilitate blind operation.

Furthermore, the operating element 14 can preferably be designed as a right-handed version or a left-handed version. Optionally, the electrically operable device 70 can selectively provide a right-handed mode or a left-handed mode, wherein an evaluation of an input by means of an input element 502 designed as a rotary wheel depends on whether the right-handed mode or the left-handed mode is active, in particular with respect to an evaluation of the direction of rotation of the rotary wheel.

By way of example, the operating element 14 has a plurality of indicator elements 509, which are arranged on the same side, by way of example on the front side 503, of the operating element 14. Preferably, all indicator elements 509 can be viewed simultaneously. Expediently, each indicator element 509 serves to display different indicator information. Expediently, several or all indicator elements 509 differ from one another in their shape.

Preferably, each indicator element 509 can have only one indicator function and/or can be assigned to one, in particular only one, parameter. For example, the electrically operable device 70, in particular the operating element 14 and/or the indicator elements 509, is designed in such a way that on each indicator element 509 the same respective indicator function and/or the same respective parameter is always displayed. There is thus preferably a fixed (in particular unchangeable) assignment between each indicator element 509 and the respective indicator function and/or the respective parameter.

Preferably, a fastening element 520 is arranged on the rear side 504—i.e. exemplarily the side facing away from the indicator elements 509—with which fastening element 520 the operating element 14 can be fastened to a fastening point, for example to a shoulder strap 19, of the electrically operable device, in particular without tools. As an example, the fastening element 520 is designed as a clip, in particular as a hook element. The electrically operable device 70 expediently has a hook-in element, for example a strap or a pocket, into which the fastening element 520 can be hooked. The attachment element is arranged on the shoulder strap 19, for example.

Expediently, in a state in which the operating element 14 is fastened with the fastening element 520, in particular to the hook-in element, all input elements 502 can be operated by the user and/or can be clearly recognized by touch. Preferably, the operating element 14 does not have to be released from its attachment, in particular does not have to be removed from the hook-in element, in order to make a user input by means of the operating element 14.

FIGS. 10 and 11 show optional variants of the operating element 14. These variants have additional buttons. Apart from the differences explained below, the variants are designed in the same way as the operating element 14 explained in connection with FIGS. 6 to 9, so that the explanations in this regard also apply to the variants shown in FIGS. 10 and 11.

Optionally, the operating element 14 comprises at least five or six, preferably exactly five or exactly six, side surfaces. The term “side surface” refers to a surface located perpendicular to the front side and/or between the front side and the rear side. By way of example, a button, in particular a maximum of one button, is arranged on each side surface, with the exception of the side surface located on the underside.

In the variant shown in FIG. 10, the lateral sides are each divided into two side surfaces, resulting in a total of six side surfaces. An input element 502 designed as a button is provided on each of two side surfaces adjacent to the upper side. These buttons will also be referred to as the first additional button 521 and the second additional button 522. An on-off input element 518 is arranged on the upper side.

In the variant shown in FIG. 11, the upper side is divided into two side surfaces. An on-off input element 518 is arranged on the first side surface of the top side adjacent to the first lateral side. A first additional button 521 is arranged on the second side surface of the top side adjacent to the second lateral side.

The side surfaces can be separated from each other by sharp edges or rounded edges. The side surfaces can be flat surfaces or have a curvature. Expediently, the side surfaces can be recognized and/or felt as individual side surfaces.

Optionally, the input elements 502 designed as buttons all have different sizes and/or all rise above the operating element housing 519 to different extents.

In the following, the design of the electrically operable device 70 as an exoskeleton 20 will be discussed in more detail.

FIG. 1 shows a schematic representation of an exoskeleton device 10 comprising the electrically operable device 70 designed as exoskeleton 20 and optionally a tool 30 and/or a mobile device 40. The exoskeleton 20 can also be provided on its own. The tool 30 and/or the mobile device 40 are exemplarily provided separately from the exoskeleton 20, i.e. in particular not mechanically connected to the exoskeleton 20. The tool 30 is, for example, a power tool, in particular a cordless screwdriver and/or a drill and/or a grinder. The mobile device 40 is preferably a smartphone or a tablet. Optionally, the exoskeleton 20 is configured to communicate with the tool 30 and/or the mobile device 40, in particular wirelessly.

As an example, the exoskeleton 20 is aligned in an upright orientation with its vertical axis (which in particular runs parallel to a base section axis 62) parallel to the z-direction. In particular, the exoskeleton 20 is aligned in the upright orientation with its sagittal axis parallel to the x-direction. In a state in which the user has put on the exoskeleton 20, the sagittal axis of the exoskeleton 20 runs parallel to the sagittal axis of the user, i.e. in particular parallel to a direction from the rear—i.e. in particular the back of the user—to the front—i.e. in particular the chest of the user. The horizontal axis of the exoskeleton 20 runs in particular in the width direction of the exoskeleton 20 and/or parallel to the y-direction. In a state in which the user has put on the exoskeleton 20, the horizontal axis of the exoskeleton 20 runs parallel to the horizontal axis of the user, i.e. in particular parallel to a direction from a first shoulder of the user to a second shoulder of the user. The vertical axis of the exoskeleton 20, the sagittal axis of the exoskeleton 20 and the horizontal axis of the exoskeleton 20 are aligned orthogonally to each other.

The exoskeleton device 10 is designed in particular for manual and/or industrial use. Preferably, the exoskeleton device 10 is not designed for medical and/or therapeutic use.

The exoskeleton 20 is an active exoskeleton and in particular has an internal energy source from which the energy for the support force is provided. In particular, the exoskeleton 20 is an active exoskeleton for actively supporting the user's shoulder joint.

The exoskeleton 20 comprises the base section 1 for attachment to a body section of a human body of a user. By way of example, the base section 1 serves to be attached to the torso 2 of the human body.

The base section 1 comprises a main section and a textile carrying system, which is in particular detachably attached to the main section. By way of example, the main section serves to be worn on the back of the human body by means of the textile carrying system, in particular in a backpack-like manner. The main section comprises a back part 8, which is in particular elongated and which is expediently aligned with its longitudinal axis vertically and/or in the longitudinal direction of the user's back. For example, the longitudinal direction of the back part 8 extends along the longitudinal direction of the back. The main section further comprises a force transmission element 18, which is in particular strip-shaped and/or rigid and extends downwards from the back part 8 to a pelvic strap 16 in order to mechanically couple the back part 8 to the pelvic strap 16. The force transmission element 18 is expediently used to transmit a reaction force, which is transmitted from a support section 3 to the back part 8, further to the pelvic strap 16. As an example, the back part 8 is tubular and/or backpack-shaped. The back part 8 is in particular rigid. In particular, the back part 8 comprises an expediently rigid back part housing, which is made, for example, from an in particular rigid plastic and/or as a hard shell. The back part 8 expediently serves to transmit a force from the support section 3 to the force transmission element 18 and/or to accommodate components for controlling the support force.

The support section 3 can expediently be referred to as an arm actuator.

The force transmission element 18 is exemplarily sword-shaped and can also be referred to as a sword. Expediently, the force transmission element 18 is designed to be adjustable relative to the back part 8, in particular in order to change the vertical extent of the main section and/or a force transmission element angle 46 between the force transmission element 18 and the back part 8 facing the user's back. Expediently, the force transmission element 18 is mounted for translational and/or rotational movement relative to the back part 8 and, in particular, can be moved into various translational and/or rotational positions relative to the back part 8 and, in particular, can be locked. The translational movement is in particular vertical. The rotational movement is expediently performed about an adjustment axis aligned parallel to the y-direction.

The textile carrying system comprises, by way of example, the pelvic strap 16 and/or at least one, preferably two, shoulder straps 19. The pelvic strap 16 expediently forms a loop so that, when worn, it surrounds the torso 2, in particular the hips, of the user. Each shoulder strap 19 extends exemplarily from the main section, in particular from the back part 8, to the pelvic strap 16, expediently over a respective shoulder of the user when the exoskeleton 20 is worn.

The exoskeleton 20 further comprises, by way of example, a force transmission element joint 17, via which the force transmission element 18 is attached to the pelvic strap 16. The force transmission element joint 17 is designed, for example, as a ball joint and can be referred to as a sacral joint. When the exoskeleton 20 is worn, the force transmission element joint 17 is arranged in the lower back region of the user, in particular centered in the width direction.

By way of example, the textile carrying system also comprises a back net 21, which is arranged on the side of the back part 8 facing the user's back. When the exoskeleton 20 is worn, the back net 21 lies against the user's back, in particular at least partially and/or in the upper back region.

The exoskeleton 20 further comprises the support section 3 movably coupled to the base section 1 for supporting a body part, preferably a limb, in particular an arm 4, of the human body of the user. In particular, the support section 3 is designed to be attached to the body part, preferably the limb, in particular the arm 4, of the user. The support section 3 comprises, by way of example, an in particular rigid arm part 11 and an arm attachment 12 arranged on the arm part 11, which is designed, by way of example, as an arm shell. The arm part 11 is exemplarily elongated and, when worn, is aligned with its longitudinal axis in the direction of the longitudinal axis of the user's arm. As an example, the arm part 11 extends from the shoulder of the user to the elbow area of the user. The exoskeleton 20, in particular the arm part 11, ends at the elbow area of the user. The arm attachment 12 is used in particular to attach the support section 3 to the arm 4, in particular the upper arm, of the user. In particular, the arm shell surrounds the upper arm of the user, in particular at least partially, so that the upper arm can be held in the arm shell with a strap. The user's forearm is expediently not attached to the exoskeleton 20.

The body part is preferably a limb of the human body. For example, the body part is an arm of the human body. Furthermore, the body part may be the back of the human body. In this case, the base section expediently serves for attachment to a leg of the human body; i.e. the body section (to which the base section is to be attached) may be, for example, a leg in the case where the body part is the back.

As an example, the support section 3 is mounted so that it can pivot about a horizontal pivot axis relative to the base section 1, in particular relative to the back part 8. As an example, the support section 3 is mounted directly on a shoulder part 29. The horizontal pivot axis can also be referred to as the lifting axis 36. When the exoskeleton 20 is worn, the lifting axis 36 is located in the area of the user's shoulder. In particular, the exoskeleton 20 is designed to support the user's shoulder joint with the support section 3. When the exoskeleton 20 is worn, the user can perform a lifting movement with his arm 4 supported by the support section 3 by pivoting the support section 3 about the lifting axis 36. In particular, the lifting axis 36 can be aligned in the y-direction. Expediently, the lifting axis 36 always lies in a horizontal plane, for example an x-y plane. In particular, a horizontal plane is to be understood as an exactly horizontal plane and/or a plane that is tilted by a maximum of 10 degrees, 7 degrees or 5 degrees relative to a horizon.

The pivot angle 47 of the support section 3 about the lifting axis 36 relative to the base section 1 should also be referred to as the lifting angle. The pivot angle 47 has a reference value, in particular a minimum value, when the support section 3 is oriented downwards (in the case of a vertically oriented exoskeleton 20) and increases continuously up to a maximum value when the support section 3 is pivoted upwards. The minimum value is in particular a minimum value in terms of amount, for example zero.

As an example, the pivot angle 47 is defined as an angle between a support section axis 61 and a base section axis 62. The support section axis 61 extends in the longitudinal direction of the support section 3. Exemplarily, the support section axis 61 extends from the lifting axis 36 in the direction of the arm attachment 12. In a state in which the user has put on the exoskeleton 20, the support section axis 61 expediently extends parallel to an upper arm axis of the arm 4 supported by the support section 3. The base section axis 62 expediently represents a vertical axis of the base section 1 and extends vertically downwards, in particular in a vertical orientation of the base section 1, for example in a state in which the user has put on the exoskeleton 20 and is standing upright. As an example, the pivot angle 47 lies in a z-x plane, for example when the user is standing upright and the arms are lifted forwards.

The exoskeleton 20 comprises, by way of example, a shoulder joint arrangement 9, via which the support section 3 is attached to the base section 1, in particular the back part 8. The shoulder joint arrangement 9 expediently comprises a joint chain with one or more pivot bearings for defining one or more vertical axes of rotation. By means of the joint chain, it is expediently possible to pivot the support section 3 relative to the base section 1, in particular relative to the back part 8, in a preferably horizontal pivot plane, for example about a virtual vertical axis of rotation. In particular, the joint chain enables the user to pivot his arm 4, which is supported by the support section 3, about a vertical axis of rotation running through the user's shoulder, whereby the support section 3 is moved along with the arm 4. As an example, the joint chain is designed to be passive, so that the exoskeleton 20 does not provide any active support force in the direction of the horizontal pivot movement when the arm is pivoted in the preferably horizontal pivot plane.

The shoulder joint arrangement 9 is expediently arranged and/or designed in such a way that it defines a free space which, when the exoskeleton 20 is worn, is located above the shoulder of the user wearing the exoskeleton 20, so that the user can align his arm, which is supported by the support section 3, vertically upwards through the free space past the shoulder joint arrangement 9.

By way of example, the shoulder joint arrangement 9 comprises an inner shoulder joint section 27, which is mounted so as to be pivotable about a first vertical axis of rotation relative to the base section 1, in particular to the back part 8, by means of a first pivot bearing of the shoulder joint arrangement 9. By way of example, the shoulder joint arrangement 9 further comprises an outer shoulder joint section 28, which is mounted so as to be pivotable about a second vertical axis of rotation relative to the inner shoulder joint section 27 by means of a second pivot bearing of the shoulder joint arrangement 9. By way of example, the shoulder joint arrangement 9 further comprises a shoulder part 29 which is mounted so as to be pivotable about a third vertical axis of rotation relative to the outer shoulder joint section 28 by means of a third pivot bearing of the shoulder joint arrangement 9. Preferably, the inner shoulder joint section 27, the outer shoulder joint section 28 and the shoulder part 29 in the shoulder joint arrangement 9 are kinematically coupled to one another as the joint chain in such a way that the pivot angle of the inner shoulder joint section 27 relative to the base section 1 determines the pivot angle of the outer shoulder joint section 28 relative to the inner shoulder joint section 27 and/or the pivot angle of the shoulder part 29 relative to the outer shoulder joint section 28.

FIG. 3 shows a schematic detailed view of the support section 3, with components arranged within the arm part visibly shown. The arm part 11 expediently comprises an arm part housing, which is in particular rigid and made of plastic, for example.

The exoskeleton 20 comprises an actuator device 5 acting on the support section 3 to provide a support force for the body part, preferably the limb, exemplarily for the user's arm. By way of example, the actuator device 5 is arranged at least partially in the arm part 11. In particular, the actuator and/or drive device 501 is the actuator device 5.

The actuator device 5 is an active actuator device. Expediently, the exoskeleton 20 provides the support force by means of the actuator device 5 with a force component acting upwards in the direction of the pivoting movement about the lifting axis 36, which pushes the user's arm 4 upwards in the direction of the pivoting movement.

Preferably, the actuator device 5 comprises an actuator unit with an actuator member 32. The actuator unit can apply an actuator force to the actuator member 32 in order to provide the support force. The actuator member 32 is coupled to an eccentric section 35 arranged eccentrically to the lifting axis 36. The eccentric section 35 is part of the shoulder part 29, for example. By coupling the actuator member 32 to the eccentric section 35, the actuator force provides a torque of the support section 3 about the lifting axis 36 relative to the base section 1 and/or the shoulder part 29. Due to this torque, the support section 3 presses against the body part, preferably the limb, in particular the arm 4, of the user, in particular upwards, and thus provides the support force acting on the body part, preferably the limb, in particular the arm 4, of the user.

As an example, the actuator device 5 has a coupling element 33, in particular designed as a push rod, via which the actuator member 32 is coupled to the eccentric section 35.

Preferably, the actuator device 5 is a pneumatic actuator device and the actuator unit is expediently designed as a pneumatic drive cylinder 31. The actuator member 32 is the piston rod of the drive cylinder 31.

Alternatively, the actuator device may not be designed as a pneumatic actuator device. For example, the actuator device can be designed as a hydraulic and/or electric actuator device and, expediently, comprise a hydraulic drive unit and/or an electric drive unit as the actuator unit.

The drive cylinder 31, the actuator member 32 and/or the coupling element 33 are preferably arranged in the arm part housing.

The exoskeleton 20 expediently comprises a lifting pivot bearing 34, which provides the lifting axis 36. As an example, the support section 3 is attached to the shoulder joint arrangement 9 via the lifting pivot bearing 34.

FIG. 4 shows a rear view of the exoskeleton 20, whereby the textile support system and the force transmission element 18 are not shown.

The exoskeleton 20 comprises, by way of example, one or more batteries 22, a compressor 23, a valve unit 24 and/or a compressed air tank 25, which are expediently part of the base section 1 and are arranged in particular in the back part housing.

By way of example, the rechargeable battery 22 is arranged at the bottom of the back part 8 and, in particular, is inserted into a rechargeable battery holder of the back part 8 from below. Expediently, the compressed air tank 25 is arranged in an upper region in the back part 8, exemplarily (in particular in the longitudinal direction of the back part 8 and/or vertical direction) above the valve unit 24, the control device 7, the compressor 23 and/or the rechargeable battery 22. The valve unit 24 and/or the control device 7 is (in particular in the longitudinal direction of the back part 8 and/or vertical direction) expediently arranged above the compressor and/or above the rechargeable battery 22. The compressor 23 is arranged (in particular in the longitudinal direction of the back part 8 and/or vertical direction) above the battery 22.

The battery 22 serves as an electrical power supply for the exoskeleton 20, in particular for the compressor 23, the valve unit 24, a sensor device 6 and/or a control device 7.

The compressor 23 is designed to compress air in order to generate compressed air. The compressed air tank 25 is designed to store compressed air—in particular the compressed air generated by the compressor 23.

The valve unit 24 expediently comprises one or more electrically operable valves and is designed in particular to influence a pneumatic connection from the compressed air tank 25 to a pressure chamber of the pneumatic drive cylinder 31, in particular to selectively establish and/or block the pneumatic connection. Expediently, the valve unit 24 is further designed to influence a pneumatic connection from the compressed air tank 25 to the environment of the exoskeleton 20 and/or a pneumatic connection from the pressure chamber of the drive cylinder 31 to the environment of the exoskeleton 20, in particular to selectively establish and/or block the pneumatic connection. The valve unit 24 is expediently part of the actuator device 5.

The exoskeleton 20 further comprises a sensor device 6. As an example, the sensor device 6 comprises an angle sensor 37 for detecting the angle of the support section 3 relative to the base section 1, in particular the arm part 11 relative to the shoulder part 29. This angle should also be referred to as the pivot angle 47 or the lifting angle. The angle sensor 37 is used in particular to detect the angle of the support section 3 about the lifting axis 36. The angle sensor 37 is designed, for example, as an incremental encoder and is arranged in particular on the lifting pivot bearing 34, in particular in the arm part 11 and/or in the shoulder part 29.

Preferably, the sensor device 6 further comprises at least one pressure sensor for detecting the pressure prevailing in the pressure chamber of the drive cylinder 31 and/or the pressure prevailing in the compressed air tank 25. The at least one pressure sensor is expediently arranged in the back part 8 and/or in the arm part 11.

The exoskeleton device 10, in particular the exoskeleton 20, expediently comprises a control device 7, which for example comprises a microcontroller or is designed as a microcontroller. The control device 7 is used in particular to control the actuator device 5, in particular the valve unit 24, in order to control the provision of the support force. Furthermore, the control device 7 is used to read out the sensor device 6, in particular to read out data recorded by the sensor device 6 and/or to communicate with the tool 30 and/or the mobile device 40. Preferably, the control device 7 is designed to adjust the pressure prevailing in the pressure chamber of the drive cylinder 31 by actuating the valve unit 24, in particular to closed-loop control the pressure, for example taking into account a pressure value recorded by means of the pressure sensor. In particular, the control device 7 is designed to increase the pressure prevailing in the pressure chamber by actuating the valve unit 24 in order to increase the support force and/or to reduce the pressure prevailing in the pressure chamber by actuating the valve unit 24 in order to reduce the support force.

According to a preferred embodiment, the control device 7 is designed to adjust the support force on the basis of the pivot angle 47 of the support section 3 detected in particular by means of the angle sensor 37. Expediently, the user can use his muscle strength to change the pivot angle 47 of the support section 3 by pivoting his arm 4, thereby influencing in particular the provision of the support force. In particular, the support force is low enough so that the user can change the pivot angle 47 of the support section 3 by pivoting his arm 4 using his muscle strength. The support force is limited, for example, by the design of the pneumatic system, in particular the compressor, and/or by the control device 7.

The control device 7 is preferably part of the exoskeleton 20 and is exemplarily arranged in the base section 1, in particular in the back part 8. Optionally, the control device 7 can be at least partially implemented in the mobile device 40.

As an example, the exoskeleton 20 comprises an operating element 14, which is expediently attached to the base section 1 via an operating element cable 15. The user can control the exoskeleton 20 via the operating element 14 and, in particular, activate, deactivate and/or set the support force to one of several possible force values greater than zero.

As an example, the exoskeleton 20 further has a connecting element 26, via which the shoulder joint arrangement 9 is attached to the base section 1, in particular the back part 8. The connecting element 26 is exemplarily designed as a pull-out element. The connecting element 26 is expediently adjustable in its position relative to the base section 1, in particular relative to the back part 8, in order to be able to adapt the position of the shoulder joint arrangement 9 and the support section 3 to the shoulder width of the user. In particular, the position of the connecting element 26 can be adjusted by pushing or pulling the connecting element 26 in or out of the back part 8.

By way of example, the exoskeleton 20 has a first support section 3A, a first shoulder joint arrangement 9A and a first connecting element 26A, as well as a second support section 3B, a second shoulder joint arrangement 9B and a second connecting element 26B. The components whose reference signs are provided with the suffix “A” or “B” are expediently each designed in correspondence with the components provided with the same reference sign number but without the suffix “A” or “B”, for example identical or mirror-symmetrical, so that the explanations in this regard apply in correspondence.

The first support section 3A, the first shoulder joint arrangement 9A and the first connecting element 26A are arranged on a first, exemplarily the right, side (in width direction) of the base section 1, and serve to support a first, in particular the right, arm of the user.

The second support section 3B, the second shoulder joint arrangement 9B and the second connecting element 26B are arranged on a second, exemplarily the left, side (in width direction) of the base section 1 and serve to support a second, in particular the left, arm of the user.

The first support section 3A comprises a first arm part 11A, a first arm attachment 12A and/or a first actuator unit, in particular a first drive cylinder.

The second support section 3A comprises a second arm part 11B, a second arm attachment 12B and/or a second actuator unit, in particular a second drive cylinder.

Preferably, the control device 7 is designed to set a first support force for the first support section 3A by means of the first actuator unit and to set a second support force for the second support section 3B by means of the second actuator unit, which second support force is expediently different from the first support force.

The first shoulder joint arrangement 9A comprises a first inner shoulder joint section 27A, a first outer shoulder joint section 28A and a first shoulder part 29A. The second shoulder joint arrangement 9B comprises a second inner shoulder joint section 27B, a second outer shoulder joint section 28B and a second shoulder part 29B.

The first support section 3A is pivotable about a first horizontal lifting axis 36A relative to the base section 1 and the second support section 3B is pivotable about a second horizontal lifting axis 36B relative to the base section 1.

In FIG. 2, the exoskeleton 20 is shown in a state in which it is worn by a user, in particular worn as intended. By the formulation that the user is wearing the exoskeleton 20, in particular wearing it as intended, it is meant that the user has put on the exoskeleton, i.e. put it on, by way of example in that the user is wearing the back part 8 on his back like a backpack, has put on the pelvic strap 16 around his hips, the shoulder strap or shoulder straps 19 run over the shoulder or shoulders of the user and/or one or both arms of the user are attached to the respective support section 3 with a respective arm attachment 12.

By way of example, the exoskeleton 20 is designed to support the user during a lifting movement of a respective arm, i.e. during an upwardly directed pivoting of the respective support section 3 about a respective lifting axis 36, with a respective support force acting in particular upwards. Furthermore, the exoskeleton 20 is expediently designed to support or counteract the user during a lowering movement, i.e. during a downward pivoting of the respective support section 3 about a respective lifting axis 36, with a respective support force acting in particular upwards, or to deactivate or reduce the respective support force during the lowering movement.

Preferably, the control device 7 has at least two manually and/or automatically selectable presets, each of which has at least one preset characteristic that defines a support force specification as a function of at least one input variable, in particular a position of the support section 3. The at least two presets differ in their preset characteristics.

The presets can also be referred to as application profiles and the preset characteristics can also be referred to as application profile characteristics. The presets are preferably stored in the control device 7.

In particular, the control device 7 has at least a first preset with a first preset characteristic and a second preset with a second preset characteristic. The first preset characteristic and the second preset characteristic each define the support force specification as a function of the at least one input variable. The first preset characteristic differs from the second preset characteristic.

Each preset characteristic represents a mapping of the at least one input variable to the support force specification. For example, each preset characteristic comprises a characteristic curve that defines the support force specification as a function of the at least one input variable. For example, each preset characteristic defines at least one respective value of the support force specification for each value of the value range of the input variable. In particular, the characteristic varies over the value range of the input variable. The characteristic curve can also be referred to as a support force characteristic curve. For example, each support force characteristic curve is a support force curve that varies over the value range of the input variable. The support force characteristic curve can, for example, be part of a support force map of the respective preset characteristic.

Preferably, the first preset characteristic and/or the second preset characteristic define a change in the support force specification as a function of the input variable, so that the support force specification is expediently not constant over the entire value range of the input variable.

The at least one input variable preferably comprises the position of the support section 3, the position of the base section 1 and/or a tool signal received from the tool 30. Furthermore, the at least one input variable may comprise a direction of movement of the support section 3 and/or a previous position, for example a previous pivot angle 47, of the support section 3. Optionally, the input variable may further comprise a speed, in particular a rotational speed, of the support section 3.

The position of the support section 3 is in particular the orientation of the support section 3 relative to the base section 1 or relative to gravity. For example, the position of the support section 3 is the pivot angle 47, in particular the current pivot angle 47. Preferably, each preset characteristic maps the pivot angle 47 to the support force specification.

The control device 7 is configured to use a preset selected from the at least two presets to determine the support force specification as a function of the input variable and to set the support force on the basis of the support force specification.

Expediently, a selection is made from the first preset and the second preset—in particular automatically or manually—and the control device 7 uses the selected preset to determine, in particular calculate, the support force specification on the basis of the at least one input variable. One or more non-selected presets are not used to calculate the support force specification. On the basis of the determined support force specification, the control device 7 sets the support force, expediently by controlling the actuator device 5, in particular the valve unit 24.

The support force specification expediently corresponds to the actuator force to be provided and/or the support force to be provided and is preferably identical to or proportional to the actuator force to be provided and/or the support force to be provided. For example, the support force specification corresponds to a pressure to be provided in the pressure chamber of the pneumatic drive cylinder 31. In particular, the support force specification is identical to or proportional to the pressure to be provided in the pressure chamber.

Preferably, the determined support force specification can be scaled by the user by means of the operating element 14, in particular a support force input element 515, and/or by means of the mobile device 40, in order to provide a scaled support force specification. The control device 7 is designed to set the support force in accordance with the scaled support force specification.

In particular, the scaled support force specification is proportional to the (non-scaled) support force specification. In particular, the scaled support force specification has the same curve shape as the (non-scaled) support force specification. For example, the control device 7 calculates the scaled support force specification by multiplying the (non-scaled) support force specification by a scaling factor.

Preferably, the user can determine the scaling by entering the scaling factor with the operating element 14, in particular the support force input element 515, and/or the mobile device 40.

Optionally, a force level of the support force can be set via the operating element 14. For example, the force level is the scaling. For example, the force level and/or the scaling can be set exclusively via the operating element 14, in particular a support force input element 515.

The operating element 14 will be discussed in more detail below.

First, the input elements 502 of the operating element 14 shall be explained. By way of example, the operating element 14 comprises as the input elements 502 a pause input element 510, a preset selection input element 511, a support force input element 515, a communication input element 517 and/or an on-off input element 518. The said input elements 510, 511, 515, 517, 518 differ expediently in their shape, in particular in such a way that each of these input elements has a different shape from the other of these input elements. Each input element 510, 511, 515, 517, 518 has a unique shape among the input elements 510, 511, 515, 17, 518, in particular among all input elements 502.

The pause input element 510 is exemplarily designed as a button and in particular arranged on the front side 503, preferably in the center.

The preset selection input element 511 is exemplarily designed as a button and is arranged in particular on the second lateral side 506, in particular in the lower half of the second lateral side 506.

The support force input element 515 is exemplarily designed as a rotary wheel. The axis of rotation of the support force input element 515 is expediently aligned normal to the front side 503 and/or parallel to the x-direction. The support force input element 515 is partially arranged in the operating element housing 519 and, by way of example, protrudes from the operating element housing 519 at the first lateral side 505 and/or at the second lateral side 506. The support force input element 515 is expediently arranged centrally, in particular in the x-direction behind the pause input element 510.

The communication input element 517 is exemplarily designed as a button and is arranged in particular on the first lateral side 505, in particular in the lower half of the first lateral side 505.

The on-off input element 518 is exemplarily designed as a button and in particular arranged on the upper side 507, in particular on the half of the upper side 507 adjoining the first lateral side 505. Preferably, the on-off input element 518 adjoins the first lateral side 505.

In a state in which the user holds and grasps the operating element 14 with his hand, in particular his right hand, in particular in such a way that the rear side 504 is in contact with the palm, the user can actuate all input elements 502 with the fingers of his right hand due to the arrangement of the input elements 502, for example the pause input element 510 with his right thumb, the preset selection input element 511 with his right ring finger and/or his right little finger, the support force input element 515 with his right thumb and/or his right middle finger, the communication input element 517 with his right thumb, and/or the on-off input element 518 with his right thumb and/or his right index finger.

The function of the individual input elements 502 will be discussed below.

The exoskeleton 20 can be set to a pause state via the pause input element 510, in which pause state the support force is switched off and the exoskeleton 20 is still switched on.

Preferably, the exoskeleton 20 comprises the compressed air tank 25 for providing compressed air for the actuator device 5, whereby in the pause state a supply pressure required for actuation of the actuator device 5 is maintained in the compressed air tank 25, in particular by the exoskeleton 20. For example, the exoskeleton 20 is designed to exhaust the pneumatic drive cylinder 31, in particular a pressure chamber of the drive cylinder 31, in the pause state in order to switch off the support force, and preferably not to exhaust the compressed air tank 25 in the pause state and in particular to leave it aerated, in particular pressurized.

Optionally, the control device 7 is designed to set, when leaving the pause state, the support force according to a force level defined before entering the pause state.

Optionally, the control device 7 is designed to set, when leaving the pause state, the support force on the basis of a preset selected before entering the pause state.

In particular, the exoskeleton 20 can be operated as follows: When the exoskeleton 20 is not in the paused state, actuation of the pause input element 510 may occur, thereby placing the exoskeleton in the paused state. When the exoskeleton 20 is in the paused state, the pause input element 510 may be actuated, causing the exoskeleton 20 to exit the paused state.

Preferably, the exoskeleton 20 can be switched forceless, in particular temporarily forceless, by means of the pause input element 510, whereby the exoskeleton 20 preferably retains last used settings, in particular a last used preset. Optionally, the force level and/or the scaling of the support force specification is set to zero by the exoskeleton 20 when the pause state is entered and remains at zero when the pause state is exited until the user sets the force level and/or the scaling to a value greater than zero by means of the support force input element 515.

The pause state can be assumed, for example, during short work breaks or when performing secondary activities without active power support from the exoskeleton 20.

Preferably, the pause input element 510 is the largest button of the operating element 14.

The exoskeleton is designed in particular as a hydraulically or pneumatically operated exoskeleton and the actuator device 5 is expediently deactivated in pause mode by opening a valve of the valve unit 24.

Optionally, the exoskeleton can have one or more electric motors as the actuator device. In this case, the support section can be disconnected from the actuator device, in particular an electric motor, in the pause state in order to switch off the support force. For example, the exoskeleton comprises a separating actuator that separates the actuator device, in particular the electric motor, from the support section, for example by means of a magnetic coupling.

Optionally, the exoskeleton 20 saves the preset used when the pause input element 510 is actuated and, for example, gradually reduces the support force to zero, optionally over several seconds, for example over a period of 1s to 5s. When exiting the pause state, settings made before entering the pause state-such as a preset selection-do not have to be made again. Furthermore, the exoskeleton 20 retains an existing pairing, in particular a Bluetooth pairing, with another device, for example the tool 30 and/or the mobile device 40, when entering and/or leaving the pause state.

Preferably, the operating element 14 further comprises a preset selection input element 511, with which at least one of the presets can be selected. In particular, it is possible to switch between several presets by actuating the preset selection input element 511.

As an example, the preset selection input element 511 is arranged on a side opposite the communication input element 517. Expediently, the preset selection input element 511 differs from the communication input element 517 in shape and/or size. In particular, the preset selection input element 511 is larger than the communication input element 517, preferably twice as large or twice as long as the communication input element 517. Expediently, an actuation of the preset selection input element 511 is only recognized by the exoskeleton 20 as a user input if the actuation is shorter than or equal to a button press time applicable to the preset selection input element 511, for example shorter than or equal to 3s.

Optionally, the operating element 14, in particular the preset selection input element 511, can be used to switch back and forth only between a limited number of presets, in particular a maximum of four presets, for example three presets stored by the manufacturer and one preset defined by the user.

Optionally, the exoskeleton 20 is configured to automatically activate one or more additional presets, for example based on communication with the tool 30, in particular in response to the tool 30 being coupled to the exoskeleton 20 via Bluetooth.

Preferably, the operating element 514 has a support force input element 515 in the form of a rotary wheel, via which the force level of the support force can be adjusted.

The support force input element 515 is expediently used to adjust the force level of the support force, for example by adjusting the scaling of the support force specification. The support force input element 515 is preferably designed as an endless rotary wheel. Expediently, the exoskeleton 20 is designed to set the force level and/or the scaling to zero each time the exoskeleton is restarted and/or each time the pause state is canceled. Expediently, each time after the force level and/or scaling has been set to zero, the user must adjust the force level and/or scaling by means of the support force input element 515 to effect a support force greater than zero.

Optionally, the support force input element 515, which is designed as a rotary wheel, is provided with a raster that can prevent the rotary wheel from being adjusted by simply brushing against clothing.

A wireless communication connection, in particular a Bluetooth connection, with an external device, in particular the tool 30 and/or the mobile device 40, can be expediently established via the communication input element 517. In particular, a Bluetooth pairing mode can be entered by actuating the communication input element 517.

Expediently, an actuation of the communication input element 517 is only recognized by the exoskeleton 20 as user input if the actuation is longer than a button press time applicable to the communication input element 517, for example longer than 3s.

The exoskeleton 20 can be switched on and off via the on-off input element 518.

Expediently, an actuation of the on-off input element 518 is only recognized by the exoskeleton 20 as a user input if the actuation is longer than a button press time applicable to the on-off input element 518, for example 2s.

Optionally, the operating element 14 has at least one preset configuration input element with which at least one preset characteristic can be configured and/or a preset can be configured and/or selected. For example, the preset configuration input element is the first additional button 521 or the second additional button 522.

For example, the exoskeleton 20 can be designed to detect a characteristic movement of the user, in particular of the user's arm 4, in response to an actuation of the preset configuration input element and to select and/or configure a preset on the basis of the detected movement. In particular, the exoskeleton 20 can be designed to record a movement of the user, in particular of the user's arm 4, in response to an actuation of the preset configuration input element and to create and/or store a preset on the basis of the recorded movement.

Optionally, by actuating the preset configuration input element, the user can set the exoskeleton 20 to a learning mode in which a pivot angle 47 currently assumed by the support section 3 is expediently stored as a configuration parameter of a preset. The configuration parameter specifies, for example, at which pivot angle 47 the provision of the support force should begin, in particular during a lifting movement of the support section 3. In particular, the configuration parameter can specify from which pivot angle 47 a constant force level of the support force should be provided. Optionally, the configuration parameter can define a pivot angle 47 for a rest position at which (in particular during a lowering movement of the support section 3) an increase in the support force is to take place, so that the user can place his arm 4 on the support section 3 at this pivot angle 47 and the arm 4 is held by the support section at this pivot angle 47.

Optionally, the user can specify a desired speed of a movement in learning mode by moving the support section 3 with his arm 4 and save it as a configuration parameter of a preset. In this case, the actuator device is designed in particular as an electric actuator device-especially as an electric motor.

Optionally, a first and a second preset configuration input element are provided, for example the first additional button 521 and the second additional button 522. For example, the first preset configuration input element is used to set the pivot angle 47 from which the support force is to be provided and/or from which the constant force level is to be provided and/or the second preset configuration input element is used to set the pivot angle 47 for the rest position.

Optionally, the support force can be modulated in two directions of movement (upward/downward movement) by means of the two preset configuration input elements. Optionally, the exoskeleton 20 can be designed to detect positions, in particular pivot angles, of the support section 3 in learning mode separately for upward and downward movement, with one preset configuration input element being assigned to the upward movement and another preset configuration input element being assigned to the downward movement.

Furthermore, a preset configuration input element can be assigned to a learning mode for the first support section 3 and another preset configuration input element can be assigned to a learning mode for the second support section 3. In particular, the preset configuration input elements can be used to separately define configuration parameters for a force support of the left arm and a force support of the right arm. Preferably, the preset configuration input element assigned to the left arm is arranged facing the left arm and the preset configuration input element assigned to the right arm is arranged facing the right arm.

Optionally, the shape of the operating element 14 in plan view has only or at most one axis of symmetry, so that the user can find a desired button by feeling the operating element 14.

In the following, the indicator elements 509 will be discussed. In particular, the indicator elements 509 comprise a support range indicator element 512, an support force indicator element 514, a preset type indicator 524, a status indicator element 525 and/or a communication indicator element 526.

Preferably, the control device 7 is configured to adjust the support force as a function of an input variable, in particular a position, for example the pivot angle 47, of the support section 3. The operating element 14 has a support range indicator element 512. The exoskeleton 20, in particular the control device 7, is configured to use the support range indicator element 512 to display a support range of the input variable, in particular of the pivot angle 47, in which support range the support force is provided and/or to display a support range of the input variable, in particular of the pivot angle 47, in which support range the support force is not provided. In particular, the exoskeleton 20 is designed to display the support range of a currently selected preset via the support range indicator element 512.

As an example, the support range indicator element 512 has several indicator areas 523, which can in particular light up separately. Expediently, each indicator area 523 is assigned to a different value range of the input variable, in particular the pivot angle 47. The exoskeleton 20 is designed to display, in particular to light up, each indicator area 523 for whose associated range of values of the input variable, in particular of the pivot angle 47, a support force greater than zero is defined, for example in a selected preset, and/or not to display, in particular not to light up, or to display differently, in particular to light up differently, each indicator area 523 for whose associated range of values of the input variable, in particular of the pivot angle 47, no support force greater than zero is defined.

Optionally, the exoskeleton 20 can be configured to display, with each indicator area 523, an indication corresponding to the specified force level, for example by the exoskeleton 20 setting the respective brightness of each indicator area 523 in accordance with the respectively assigned specified force level and/or by the exoskeleton 20 setting a respective size, in particular a respective width, of a respective partial area of each indicator area 523 to be displayed, in particular to be illuminated, in accordance with the respectively assigned specified force level. In particular, the exoskeleton 20 displays the indication by means of a variation in the brightness between the indicator areas 523 or a displayed width of the respective indicator area 523.

By way of example, the support range indicator element 512 displays the preset used, in particular the support range defined by the preset used, for example a working height. By way of example, the support range indicator element 512 comprises a representation, in particular a pictogram, in the form of a person, for example a man. By way of example, the representation, in particular the pictogram, comprises a head, torso and arms. The indicator areas 523 are exemplarily arranged next to and/or around the representation, in particular in such a way that for each indicator area 523 the respectively assigned value range corresponds to the vertical position of that body section of the representation next to which the indicator area 523 is arranged.

By way of example, the indicator areas 523 are designed as horizontal bars which are interrupted by the representation, in particular the pictogram.

The pictogram can reduce the risk of misinterpreting the indicator areas 523, for example when the operating element 14 is held upside down. The support range is the range in which the user experiences active power support from the support section 3. As an example, the support range indicator element 512 is divided into the three indicator areas 523, which are designed in particular as three horizontal sections that represent different support areas of the activated preset. Optionally, the support range indicator element 512 may have more or less than three indicator areas, in particular three horizontal sections.

Optionally, the operating element 14 further comprises a preset type indicator 524 for displaying the type of the currently selected preset. For example, the exoskeleton 20 is configured to use the preset type indicator 524 to display whether or not the currently selected preset is a preset configured by the user. For example, the exoskeleton 20 causes the preset type indicator 524 to light up in response to the fact that the currently selected preset is a preset configured by the user, and does not cause the preset type indicator 524 to light up in response to the fact that the currently selected preset is not a preset configured by the user but, for example, a preset stored by the manufacturer. As an example, the preset type indicator 524 is designed as a horizontal indicator bar below the support range indicator element 512.

Optionally, the operating element 14 comprises a display, for example an LCD display. Expediently, the display can be designed to depict, in particular display, the functions of the preset type indicator 524, the support range indicator element 512 and/or the status indicator element 526.

Preferably, the operating element 14 comprises a support force indicator element 514. The exoskeleton 20, in particular the control device 7, is configured to display a force level of the support force via the support force indicator element 514, in particular continuously or in several different stages. The support force indicator element 514 is exemplarily designed in the form of a ring section and/or arranged above the pause input element 510. Expediently, the exoskeleton 20 is configured to visualize, when the support force input element 515 is rotated, a respectively set force level by means of an illumination in the support force indicator element 514, in particular corresponding to a current direction of rotation of the support force input element 515. Expediently, the ring-section-shaped support force indicator element 514 is arranged concentrically with the support force input element 515. In this way, an intuitive understanding of the support force indicator element 514 by the user can be achieved.

The status indicator element 525 is used to display the current status of the electrically operable device 70, in particular the exoskeleton 20 or the suction device 80. For example, the electrically operable device 70, in particular the exoskeleton 20 or the suction device 80, is designed to use the status indicator element 525 to display the pause status, an error status and/or a charge status of the one or more rechargeable batteries 22 as a status.

For example, the electrically operable device 70, in particular the exoskeleton 20 or the suction device 80, indicates a fault-free and operational state of the electrically operable device 70, in particular the exoskeleton 20 or the suction device 80, by means of a first optical output signal, for example a green illumination, of the status indicator element 525. In particular, this status is displayed after the electrically operable device 70, in particular the exoskeleton 20 or the suction device, is switched on. Optionally, other information is only displayed via the status indicator element 525 when the support force input element 515 or another input element 502 is actuated.

Optionally, the status indicator element 525 displays a second visual output signal, in particular a pulsing red light, in response to the fact that the charge level of the one or more batteries 22 has fallen below a threshold value. Preferably, the operating element indicates which of the plurality of rechargeable batteries 22 has fallen below a threshold value of the charge level.

Optionally, the status indicator element 525 displays a third optical output signal, for example a constant red light, in response to the fact that an error is present. Preferably, the electrically operable device 70, in particular the exoskeleton 20 or the suction device 80, deactivates the other indicator elements 509 in this case.

Preferably, the status indicator element 526 displays a fourth visual output signal, such as a pulsing green flash, in response to the pause state being present.

The communication indicator element 526 is used in particular to indicate the status of a communication connection, in particular a Bluetooth connection, with an external device, for example the tool 30 and/or the mobile device 40. For example, the communication indicator element 526 flashes blue during a pairing procedure. After successful pairing, the communication indicator element 526 lights up blue constantly. The communication indicator element 526 is preferably arranged close to the communication input element 517.

Expediently, a communication module, for example a Bluetooth module, and/or an identification module, for example an RFID chip, of the electrically operable device 70 can be arranged in the operating element 14. Optionally, the electrically operable device 70, in particular the exoskeleton 20 or suction device 80, communicates and/or is identified with the tool 30 and/or the mobile device 40 via the operating element 14.

Optionally, the electrically operable device 70, in particular the exoskeleton 20 or the suction device 80, is designed to emit a vibration signal and/or an acoustic signal by means of the operating element 14 in order to indicate to the user a current state of the electrically operable device 70, in particular of the exoskeleton 20 or the suction device 80.

Optionally, the operating element 14 has a vibration function, with the aid of which the user is made aware of certain (abnormal or special) statuses or status changes. Such an abnormal status can be, for example, an error message or the battery pack(s) 22 falling below a certain charge level.

Optionally, the operating element 14 is designed to emit an acoustic signal, for example a beep or a sequence of beeps, with the aid of which the user is made aware of certain (abnormal or special) statuses or status changes.

Preferably, the operating element 14 is connected to the base section 1, in particular the back part 8, of the exoskeleton 20 via a cable, in particular the operating element cable 15.

Preferably, the operating element 14 is supplied with power via the operating element cable 15 and does not require its own rechargeable battery or batteries.

Expediently, the cable length of the operating element cable 15 is not variable and/or the operating element cable 15 cannot be stretched, in particular it is not a coiled cable. This has the advantage that the operating element 14 can also dangle around on the operating element cable 15 and the user still intuitively knows where to feel for the operating element 14.

Optionally, the cable, in particular the operating element cable 15, is dimensionally stable and has a sufficiently high bending stiffness so that the operating element 14 is held in one position in space by the cable due to the bending stiffness of the cable.

As an example, the operating element cable 15 is routed to the back part 8 on or in the shoulder strap 19. For example, the shoulder strap 19 has a pocket 527, which can be closed in particular by press studs, through which pocket 527 the operating element cable 15 is routed.

Expediently, the operating element 14 can be attached to the shoulder strap 19, in particular to an attachment point on the shoulder strap 19, by means of the fastening element 520. In the state attached to the shoulder strap 19, the operating element 14 (in particular with the support section 3 oriented downwards) is located, by way of example, at a height between the arm attachment 12 and the shoulder joint arrangement 9, in particular at the height of the user's chest.

FIG. 12 shows an exemplary embodiment of the electrically operable device 70 as a suction device 80. The suction device 80 is in particular a vacuum cleaner. The suction device 80 comprises the actuator and/or drive device 501, which is designed as a suction unit 516 accommodated in the base section 1. The suction device 80 further comprises a suction hose 529 connected to the suction unit 516. A hose nozzle 528 is arranged on the suction hose 529 as an example.

As an example, the suction device 80 has one or two shoulder straps 19 and can in particular be worn on the user's back.

The suction device 80 comprises the operating element 14. FIG. 12 shows two preferred positionings of the operating element 14, whereby expediently only one positioning is present in each case—and in particular only one operating element 14 is present.

Preferably, the operating element 14 is attached to the hose nozzle 528, in particular permanently mounted or attached with a strap or a clip. When working with a power tool coupled to the suction device 80, the user can operate the suction device 80 via the operating element 14. Optionally, a connecting cable is routed together with the suction hose 529 to the base section 1 or communication with the base section 1 is via Bluetooth.

In particular, in the case where the suction device 80 is a suction device 80 worn by the user on the back, the operating element 14 can be attached to the shoulder strap 19, a belt or a lap belt and/or connected to the base section 1 via the operating element cable 15. Furthermore, the operating element can be attached to the user's clothing and/or communicate with the base section 1 via Bluetooth.

Expediently, the operating element 14 comprises a rotary wheel as an input element for setting the suction power. Furthermore, the operating element 14 can comprise a button as an input element in order to initiate manual cleaning of a filter of the suction device 80.

Optionally, an operating element 14 is provided which can be connected to various electrical devices, for example the exoskeleton 20, the suction device 80, a light emitter, a loudspeaker and/or the tool 30, in particular by means of Bluetooth. For example, the operating element 14 comprises a button that can be used to switch back and forth between various electrical devices coupled to the operating element 14. Optionally, the operating element comprises a display, for example an LCD display, which indicates which of the coupled electrical devices can currently be operated with the operating element 14.

For example, the operating element 14 can be used to adjust the brightness of the spotlight and/or the volume of a speaker connected via Bluetooth using the rotary wheel.

1. An electrically operable device, comprising:
a base section for attachment to a body section of the human body,
an actuator and/or drive device,
a control device for controlling the actuator and/or drive device, and
an operating element which is used for user input into the control device and which can be operated manually by the user of the electrically operable device during use of the electrically operable device.

2. The electrically operable device according to claim 1, wherein the operating element is designed as a manually grippable manual operating element.

3. The electrically operable device according to claim 1, wherein the operating element has a plurality of input elements which are arranged in such a way that all input elements can be operated by a hand grasping the operating element and thereby holding it.

4. The electrically operable device according to claim 1, wherein the operating element has a plurality of input elements which are arranged on different sides and/or on different surfaces of the operating element.

5. The electrically operable device according to claim 1, wherein the operating element has a plurality of input elements, each of which differs from one another in its shape, size, optical and/or haptic structure.

6. The electrically operable device according to claim 1, wherein the operating element comprises a plurality of indicator elements arranged on the same side of the operating element, each indicator element serving to display a different indicator information.

7. The electrically operable device according to any claim 1, wherein the electrically operable device is an exoskeleton comprising:
a support section movably coupled to the base section for supporting a body part of the human body, and
wherein the actuator and/or drive device is an actuator device acting on the support section for providing a support force for the body part.

8. The electrically operable device according to claim 7, wherein the operating element has a pause input element via which the exoskeleton can be set to a pause state in which the support force is switched off and the exoskeleton is still switched on.

9. The electrically operable device according to claim 8, further comprising a compressed air tank for providing compressed air for the actuator device, wherein the electrically operable device is configured to maintain, in the pause state, a supply pressure in the compressed air tank, the supply pressure being required for actuation of the actuator device.

10. The electrically operable device according to claim 8, wherein the control device is configured to set, when leaving the pause state, the support force according to a force level determined before entering the pause state.

11. The electrically operable device according to claim 7, wherein the control device has at least two manually and/or automatically selectable presets, each of which has at least one preset characteristic which defines a support force specification as a function of at least one input variable, wherein the at least two presets differ in their preset characteristic, and wherein the control device is configured to determine the support force specification using a preset selected from the at least two presets, wherein the at least two presets differ in their preset characteristics, and wherein the control device is configured to determine the support force specification as a function of the input variable using a preset selected from the at least two presets and to set the support force on the basis of the support force specification.

12. The electrically operable device according to claim 11, wherein the operating element has a pause input element via which the exoskeleton can be set to a pause state in which the support force is switched off and the exoskeleton is still switched on, wherein the control device is configured to set, when leaving the pause state, the support force on the basis of a preset selected before entering the pause state.

13. The electrically operable device according to claim 11, wherein the operating element further comprises a preset selection input element with which at least one of the presets can be selected.

14. The electrically operable device according to claim 11, wherein the operating element further comprises a preset configuration input element with which at least one preset characteristic can be configured.

15. The electrically operable device according to claim 7, wherein the control device is configured to set the support force as a function of an input variable, and the operating element has a support range indicator element and the exoskeleton is designed to display, via the support range indicator element, a support range of the input variable in which the support force is provided.

16. The electrically operable device according to claim 7, wherein the operating element further comprises a support force indicator element, wherein the exoskeleton is configured to indicate a force level of the support force via the support force indicator element.

17. The electrically operable device according to claim 7, wherein the operating element has a support force input element in the form of a rotary wheel, via which the force level of the support force can be adjusted.

18. The electrically operable device according to claim 7, wherein the operating element is connected to the base section of the exoskeleton via a cable.

19. The electrically operable device according to claim 18, wherein the cable is dimensionally stable and has a sufficiently high bending stiffness so that the operating element is held in a position in space by the cable due to the bending stiffness of the cable.

20. The electrically operable device according to claim 1, wherein the electrically operable device is a suction device, comprising:
a suction unit accommodated in the base section and
a suction hose fluidically connected to the suction unit.

21. A method of operating an electrically operable device according to claim 1, comprising the step of:
carrying out the user input using the operating element.

22. A method of operating an electrically operable device according to claim 8, comprising the steps of:
when the exoskeleton is not in the pause state, actuating the pause input element, whereby the exoskeleton is set to the pause state, and/or
when the exoskeleton is in the pause state, actuating the pause input element, causing the exoskeleton to leave the pause state.

23. The electrically operable device according to claim 1, wherein the electrically operable device is designed as an exoskeleton or as a suction device.

24. The electrically operable device according to claim 1, wherein the base section is for attachment to the torso of the human body.

25. The electrically operable device according to claim 7, wherein the support section is for supporting an arm of the human body.

26. The electrically operable device according to claim 11, wherein the input variable is a position of the support section.
